(19) United States
(12) Patent Application Publication
(10) Pub. No.: US 2024/0279257 A1
(43) Pub. Date: Aug. 22, 2024

(54) BIFUNCTIONAL SILICON BASED PHOTOINITIATORS

(71) Applicant: IGM RESINS ITALIA S.R.L., Milano (MI) (IT)

(72) Inventors: Marika MORONE, Lipomo (CO) (IT); Gianni CASALUCE, Turate (LC) (IT); Vincenzo RAZZANO, Bussero (MI) (IT)

(21) Appl. No.: 18/566,976

(22) PCT Filed: Jun. 7, 2022
(86) PCT No.: PCT/EP2022/065318

§ 371 Date: Dec. 4, 2023

(30) Foreign Application Priority Data
Jun. 8, 2021 (IT) 102021000014885

(51) Int. Cl. C07F 7/18; B29C 64/112; B29C 64/264; B33Y 10/00; B33Y 30/00; B33Y 70/00; C08F 120/36; C09D 4/00; C09D 11/101; C09D 11/107; C09D 133/14

(52) U.S. Cl. CPC C07F 7/1804; B33Y 70/00; C08F 120/36; C09D 4/00; C09D 11/101; C09D 11/107; C09D 133/14; B29C 64/112; B29C 64/264; B33Y 10/00; B33Y 30/00

(57) ABSTRACT

The present invention relates to a novel series of bifunctional silicon based photoinitiators with improved reactivity and surface curing and their use in photopolymerization compositions. The invention also concerns a process for the photopolymerization of compositions comprising said photoinitiators, and their use in articles of manufacture, including printed, coated, and fabricated assemblies.

### SUMMARY OF THE INVENTION

The present invention relates to a novel series of bifunctional silicon based photoinitiators with improved reactivity and surface curing and their use in photopolymerization compositions. The invention also concerns a process for the photopolymerization of compositions comprising said photoinitiators, and their use in articles of manufacture, including printed, coated, and fabricated assemblies.

### PRIOR ART

In the last years, the design and the development of new photoinitiators (PIs) has been attracted increasing attention due to the large amount of photoinitiators that have been or are going to be banned as toxic or reprotoxic.

A wide variety of Norrish type I and type II photoinitiators were reported in literature, some examples are acylgermanium photoinitiators (EP3150641, EP2649981), benzoyl phenyltelluride PIs (Macromolecules, 2014, 47(16), 5526-5531), silicon based PIs (JP2010229169, Macromolecules, 2009, 5 42(16), 6031-6037, Macromolecules 2007, 40(24), 8527-8530, Macromol. Rapid Commun. 2017, 38, 1600470, Macromolecules, 2017, 50(17), 6911-6923, WO2020136522), ketocoumarins (US2015259316, EP3472140).

Among these classes, the silicon based PIs have attracted a lot of attention due to their ability of working at both Hg and LED wavelengths and being sensitized. Unfortunately, when used in standard applications these photoinitiators showed their major limitation, the surface curing.

This drawback strongly limited the use of these photoinitiators and even the use of an amine was not able to fully overcome this problem.

So, there exists the need of a technical solution able to improve the surface cure of the silicon based PIs without affecting the good reactivity of this products.

### AIMS OF THE INVENTION

It is a first aim of the invention to provide for novel photocurable compositions comprising bifunctional silicon based PIs.

It is a further aim of the invention to provide for novel bifunctional silicon based PIs, their use as photoinitiators and photocurable compositions comprising them.

Is a further aim of the invention to provide for processes for photocuring ethylenically unsaturated compounds using bifunctional silicon based PIs, as well as articles of manufacture made by said process.

### DESCRIPTION OF THE INVENTION

We surprisingly discovered that when a benzoyl moiety is built on a silicon based PIs the reactivity is unexpectedly increased together with the surface curing. The new compounds are able to well cure in both deep and surface under Hg and LED lamp. Moreover, the ability to be sensitized is preserved and the reactivity in clear coating under LED is incredibly increased. The new compounds were tested in different formulations and compared to the silicon based PIs of the prior art demonstrating their good performance.

Therefore, the present invention relates to specific bifunctional silicon based PIs useful as photoinitiators, compositions comprising said photoinitiators and a process for the photopolymerization of compositions comprising said bifunctional silicon based PIs.

According to one of its aspects, the present invention relates to a photopolymerizable composition comprising:
a) from 50 to 99.9%, preferably from 70 to 98.9% by weight, based on the total content of the composition of at least one ethylenically unsaturated compound; and
b) from 0.1 to 35%, preferably from 0.1 to 20%, and more preferably from 0.2 to 15% by weight, based on the total content of the composition, of at least one compound of formula (I) or (II)

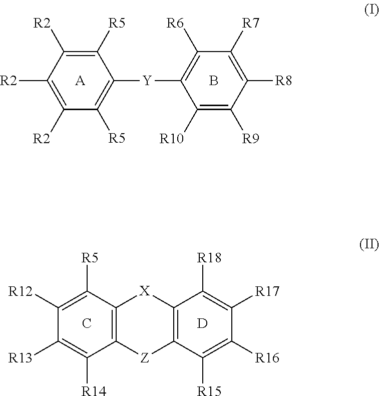

wherein:
at least one of R₁, R₂, R₃, R₄, R₅, R₆, R₇, R₈, R₉ and R₁₀ and at least one of R₁₁, R₁₂, R₁₃, R₁₄, R₁₅, R₁₆, R₁₇, R₁₈ are a group of formula (III);

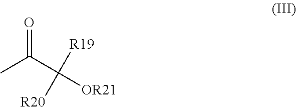

at least one of R₁, R₂, R₃, R₄, R₅, R₆, R₇, R₈, R₉ and R₁₀ and at least one of R₁₁, R₁₂, R₁₃, R₁₄, R₁₅, R₁₆, R₁₇, R₁₈ are a group of formula (IV)

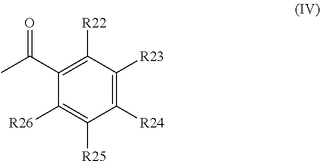

and the others, each independently, are selected from hydrogen, halogen, substituted or unsubstituted C1-C20 alkyl, C5-C7 cycloalkyl, C3-C12 alkenyl, —O(C3-C12 alkenyl), —S(C3-C12 alkenyl), aryl, substituted or unsubstituted C1-C20 alkoxy, C1-C50 alkyl which is interrupted by one or more oxygens, C5-C7 cycloalkoxy, aryloxy, substituted or unsubstituted C1-C20 alkylthio, arylthio, substituted or unsubstituted (C1-C12alkyl)₂amino, (C5-C7cycloalkyl)₂amino, morpholino, piperidino, piperazino and N(C1-C12alkyl)piperazino; R₁₉ and R₂₀ are, each independently, selected from C1-C20 alkyl, C5-C7 cycloalkyl, benzyl and CH2tolyl;
R₂₁ is selected from Si(C1-C12alkyl)₂Si(C1-C12alkyl)₃, Si(C1-C12alkyl)₃, Si(Si(C1-C12alkyl)₃)₃, Si(C1-C12alkyl)₂Si(C1-C12alkyl)₂Si(C1-C12alkyl)₃, Si(C1-C12alkyl)₂Si(C1-C12alkyl)₂Si(C1-C12alkyl)₂Si(C1-C12alkyl)₃, Si(aryl)₃ and Si(aryl)₂Si(aryl)₃;
R₂₂, R₂₃, R₂₄, R₂₅ and R₂₆ are, each independently, selected from hydrogen, halogen, substituted or unsubstituted C1-C20 alkyl, C3-C12 alkenyl, COOH, COO(C1-C12 alkyl), O(C3-C12 alkenyl), S(C3-C12 alkenyl), C5-C7 cycloalkyl, aryl, substituted or unsubstituted C1-C20 alkoxy, C1-C50 alkyl which is interrupted by one or more oxygens, C5-C7 cycloalkoxy, aryloxy, substituted or unsubstituted C1-C20alkylthio, arylthio, substituted or unsubstituted (C1-C12alkyl)₂amino, (C5-C7cycloalkyl)₂amino, morpholino, piperidino, piperazino and N(C1-C12alkyl)piperazino; X, Y and Z are each independently selected from O, S, Se, SO, SO2, NH, N(C1-C12alkyl), N-aryl, a direct bond, CH₂, C(C1-C12alkyl)₂, C(C1-C12alkoxy)₂, CH(C1-C12alkyl), CH(C1-C12alkoxy), CHOH, C(aryl)₂, CH(aryl), C(aryloxy)₂ and CH(aryloxy);
as well as salts and/or solvates thereof; and
c) from 0 to 20% by weight, preferably from 0 to 15%, and more preferably from 0.2 to 15% by weight, based on the total content of the composition, of an accelerator and/or a coinitiator.

According to the present invention, the terms “photocuring” and “photopolymerizing” and related terms, are synonyms.

The expression “based on the total content of the composition” means that the % weight amounts of any of the components is calculated with respect to the sum of the weight of the components of the composition, including any further additional components in addition to a), b) and c) above, but possible water and/or solvents which can be present in the composition are not considered for the calculation of said % weight amounts.

According to a preferred embodiment, R21 is not a trimethylsilyl group.

According to another of its aspects, the present invention relates to a compound of formula (I) or (II)

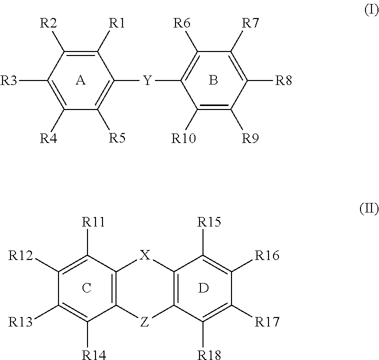

wherein:
at least one of R₁, R₂, R₃, R₄, R₅, R₆, R₇, R₈, R₉ and R₁₀ and at least one of R₁₁, R₁₂, R₁₃, R₁₄, R₁₅, R₁₆, R₁₇, R₁₈ are a group of formula (III);

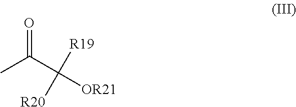

at least one of R₁, R₂, R₃, R₄, R₅, R₆, R₇, R₈, R₉ and R₁₀ and at least one of R₁₁, R₁₂, R₁₃, R₁₄, R₁₅, R₁₆, R₁₇, R₁₈ are a group of formula (IV)

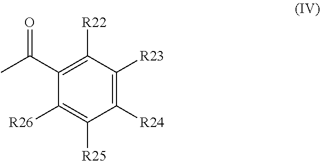

and the others, each independently, are selected from hydrogen, halogen, substituted or unsubstituted C1-C20 alkyl, C5-C7 cycloalkyl, C3-C12 alkenyl, —O(C3-C12 alkenyl), —S(C3-C12 alkenyl), aryl, substituted or unsubstituted C1-C20 alkoxy, C1-C50 alkyl which is interrupted by one or more oxygens, C5-C7 cycloalkoxy, aryloxy, substituted or unsubstituted C1-C20 alkylthio, arylthio, substituted or unsubstituted (C1-C12alkyl)₂amino, (C5-C7cycloalkyl)₂amino, morpholino, piperidino, piperazino and N(C1-C12alkyl)piperazino;
R₁₉ and R₂₀ are, each independently, selected from C1-C20 alkyl, C5-C7 cycloalkyl, benzyl and CH2tolyl;
R₂₁ is selected from Si(C1-C12alkyl)₂Si(C1-C12alkyl)₃, Si(C1-C12alkyl)₃, Si(Si(C1-C12alkyl)₃)₃, Si(C1-C12alkyl)₂Si(C1-C12alkyl)₂Si(C1-C12alkyl)₃, Si(C1-C12alkyl)₂Si(C1-C12alkyl)₂Si(C1-C12alkyl)₂Si(C1-C12alkyl)₃, Si(aryl)₃ and Si(aryl)₂Si(aryl)₃;
R₂₂, R₂₃, R₂₄, R₂₅ and R₂₆ are, each independently, selected from hydrogen, halogen, substituted or unsubstituted C1-C20 alkyl, C3-C12 alkenyl, COOH, COO(C1-C12 alkyl), O(C3-C12 alkenyl), S(C3-C12 alkenyl), C5-C7 cycloalkyl, aryl, substituted or unsubstituted C1-C20 alkoxy, C1-C50 alkyl which is interrupted by one or more oxygens, C5-C7 cycloalkoxy, aryloxy, substituted or unsubstituted C1-C20alkylthio, arylthio, substituted or unsubstituted (C1-C12alkyl)₂amino, (C5-C7cycloalkyl)₂amino, morpholino, piperidino, piperazino and N(C1-C12alkyl)piperazino;
X, Y and Z are each independently selected from O, S, Se, SO, SO2, NH, N(C1-C12alkyl), N-aryl, a direct bond, CH2, C(C1-C12alkyl)₂, C(C1-C12alkoxy)₂, CH(C1-C12alkyl), CH(C1-C12alkoxy), CHOH, C(aryl)₂, CH(aryl), C(aryloxy)₂ and CH(aryloxy);
as well as salts and/or solvates thereof.

According to a preferred embodiment, R21 is not a trimethylsilyl group.

According to another of its aspects, the present invention relates to a process for photocuring photopolymerizable compositions coatings, adhesives and inks, which process comprises:
providing a photopolymerizable composition as above defined;
coating or printing said photopolymerizable composition onto a substrate, and
photocuring said coated or printed composition with a light source on said substrate.

According to another of its aspects, the present invention relates to a process for three-dimensional printing which comprising photocuring with a light source a mixture comprising the composition as above defined.

### DETAILED DESCRIPTION OF THE INVENTION

In the present description the expressions “alkyl” or “alkyl group” mean, where not differently indicated, a linear or branched, saturated alkyl chain containing the given number of carbon atoms and includes all possibility for each number of carbon atoms in the alkyl group, i.e. for three carbon atoms: n-propyl and isopropyl; for four carbon atoms: n-butyl, isobutyl and tertiary-butyl; for five carbon atoms: n-pentyl, 1,1-dimethyl-propyl, 2,2-dimethylpropyl and 2-methyl-butyl, etc.

“Alkenyl” or “alkenyl group” mean an unsaturated group containing from 2 to 12 carbon atoms, preferably C3 to C12 carbon atoms, which can be, for example, allyl, methallyl or undecenyl.

The expressions “cycloalkyl” or “cycloalkyl group” mean, where not differently indicated, an aliphatic ring containing 5 or 6 carbon atoms which can be cyclopentyl or cyclohexyl.

The expressions “aryl” or “aryl group” include, but it is not limited to, for example a substituted or unsubstituted aryl group, such as a substituted or unsubstituted phenyl group, a substituted or unsubstituted naphthyl group, an anthracenyl group, an indenyl group, a fluorenyl group.

The expression “C1-C50 alkyl which is interrupted by one or more oxygens” means that, in case more than one oxygen atom is present, said oxygen atoms are separated from one another by at least one methylene group, i.e. the oxygen atoms are non-consecutive. Examples include the following: —O—CH₂—OCH₃, —O—CH₂CH₂—OCH₂CH₃, —O—[CH₂CH₂O]ᵥCH₃, —O—[CH₂CH₂O]ᵥOH, —O—[CH₂CH₂O]ᵥCH₂CH₃, —CH₂—O—[CH₂CH₂O]ᵥCH₃ with v=1-24, —O—[CH₂CH₂CH₂O]ₚOH, —O—[CH₂CH₂CH₂O]ₚCH₃, —O—[CH₂CH₂CH₂O]ₚCH₂CH₃, —CH₂—O—[CH₂CH₂CH₂O]ₚCH₃ with p=1-16.

When a group is substituted, the term “substituted” means that said group bears one or more substituents, said substituents being preferably selected from halogen atom, alkyl, cycloalkyl, alkoxy, alkylamino, dialkylamino, alkylthio or arylthio group, heterocyclic groups; more preferably selected from methyl, ethyl, isopropyl, tert-butyl, phenyl, trifluoromethyl, cyano, acetyl, ethoxycarbonyl, carboxyl, carboxylate, amino, methylamino, dimethylamino, ethylamino, diethylamino, isopropylamino, diisopropylamino, cyclohexylamino, dicyclohexylamino, acetylamino, piperidino, pyrrolidyl, methoxy, ethoxy, propoxy, isopropoxy, butoxy, pentyloxy, phenoxy, hydroxyl, acetoxy, —PO₃H, methylthio, ethylthio, i-propylthio, n-propylthio, phenyltio, mercapto, acetylthio, thiocyano, methylsulfinyl, methylsulfonyl, dimethylsulfonyl, sulfonate groups, fluorine atom, chlorine atom, bromine atom, iodine atom, trimethylsilyl, pentamethyldisilyl, triethylsilyl, trimethylstannyl, furyl, thienyl, pyridyl and morpholino.

The expression “a direct bond” means that Y, X or Z are not present, and a direct bond links the two rings A-B or C-D.

According to preferred embodiments of the present invention:
i. at least one of R₁, R₂, R₃, R₄, R₅, R₆, R₇, R₈, R₉ and R₁₀ and at least one of R₁₁, R₁₂, R₁₃, R₁₄, R₁₅, R₁₆, R₁₇, R₁₈ are a group of formula (III)

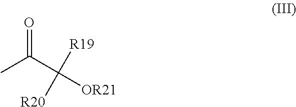

and
   at least one of R₁, R₂, R₃, R₄, R₅, R₆, R₇, R₈, R₉ and R₁₀ and at least one of R₁₁, R₁₂, R₁₃, R₁₄, R₁₅, R₁₆, R₁₇, R₁₈ are a group of formula (IV)

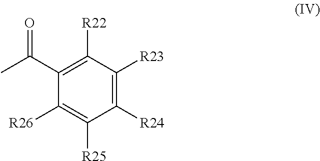

ii. and the others are hydrogen; and/or
iii. Y is selected from O, S, CH₂, CHOH, CH(C1-C12alkoxy), a direct bond, more preferably S, O and C(C1-C12alkoxy); and/or
iv. Z is selected from O, S, CH₂, N(C1-C12alkyl), C(C1-C12alkyl)₂, a direct bond, more preferably O, S, CH₂ and C(C1-C12alkyl)₂; and/or
v. X is selected from a direct bond, C(C1-C12alkyl)₂, S, CH₂, more preferably a direct bond and CH₂, C(C1-C12alkyl)₂; and/or
vi. R₁₉ and R₂₀ are C1-C12alkyl, preferably, each independently, methyl and ethyl, more preferably both are methyl; and/or
vii. R₂₁ is selected from Si(C1-C12alkyl)₂Si(C1-C12alkyl)₃ and Si(C1-C12alkyl)₃, more preferably Si(C1-C12alkyl)₂Si(C1-C12alkyl)₃, more preferably Si(methyl)₂Si(methyl)₃; and/or
viii. R₂₂, R₂₃, R₂₅, and R₂₆ are hydrogen; and/or
ix. R₂₄ is selected from hydrogen, halogen, substituted or unsubstituted C1-C20 alkyl, aryl, substituted or unsubstituted C1-C20 alkoxy, C1-C50 alkyl which is interrupted by one or more oxygens, aryloxy, substituted or unsubstituted C1-C20alkylthio, arylthio, substituted or unsubstituted (C1-C12alkyl)₂amino, (C5-C7cycloalkyl)₂amino, morpholino, piperidino, piperazine and N(C1-C12alkyl)piperazino, more preferably R₂₄ is selected from hydrogen, substituted or unsubstituted C1-C20alkylthio, substituted or unsubstituted (C1-C12alkyl)₂amino, (C5-C7cycloalkyl)₂amino, morpholino, piperidino, piperazine and N(C1-C12alkyl)piperazino, more preferably R₂₄ is selected from hydrogen, morpholino and N(C1-C12alkyl)piperazino.

According to a preferred embodiment, all the above preferred embodiments (i) to (ix) are combined.

According to a preferred embodiment, only one group of formula (III) and only one group of formula (IV) are present in compounds of formula (I) and (II).

According to a more preferred embodiment, only one group of formula (III) and only one group of formula (IV) are present in compounds of formula (I) and (II), and one of the two groups is bound to ring A or C and the other to ring B or D of the compounds of formula (I) and (II). Otherwise said, preferably, if ring A bears the group of formula (III) then ring B bears the group of formula (IV) and vice-versa. The same applies to rings C and D.

According to a preferred embodiment, R₁₉ and R₂₀ are methyl or ethyl, more preferably both are methyl; and R₂₁ is Si(C1-C12alkyl)₂Si(C1-C12alkyl)₃ and Si(C1-C12alkyl)₃, more preferably Si(methyl)₂Si(methyl)₃. According to a preferred embodiment, R₂₁ is not a trimethylsilyl group.

The compounds represented by formulae (I) and (II) can be prepared according to conventional methods known to the skilled in the art starting from the corresponding α-hydroxyketones as described for example in WO2020/136522.

According to the invention, the photoinitiators of formulae (I) and (II) can be used to prepare photocurable compositions comprising ethylenically unsaturated compounds (a). Said unsaturated compounds (a) can contain one or more olefinic double bonds. They can be low-molecular weight (monomeric) or high-molecular weight (oligomeric) compounds.

Examples of suitable low molecular weight monomers (monomeric compounds) having one double bond are alkyl or hydroxyalkyl acrylates or methacrylates, such as methyl-, ethyl-, butyl-, 2-ethylhexyl-,2-hydroxyethyl- or isobornyl-acrylate; and methyl or ethyl methacrylate.

Further examples are resins modified with silicon or fluorine, e.g. silicone acrylates. Further examples of these monomers are acrylonitrile, acrylamide, methacrylamide, N-substituted (meth)acrylamides, styrene, alkylstyrenes and halogeno styrenes, vinyl esters such as vinyl acetate, vinyl ethers such as iso-butyl vinyl ether, N-vinylpyrrolidone, vinyl chloride or vinylidene chloride.

Examples of monomers having more than one double bond are the ethylene glycol diacrylate, propylene glycol diacrylate, neopentyl glycol diacrylate, hexamethylene glycol diacrylate, bisphenol A diacrylate, 4,4′-bis-(2-acryloyloxyethoxy)-diphenylpropane, trimethylolpropane triacrylate, pentaerythritol triacrylate or tetraacrylate, vinyl acrylate, divinyl benzene, divinyl succinate, diallyl phthalate, triallyl phosphate, triallyl isocyanurate or tris-(2-acryloylethyl) isocyanurate.

Examples of high-molecular weight (oligomeric) polyunsaturated compounds are acrylated epoxy resins, acrylated or vinyl-ether- or epoxy-group-containing polyesters, acrylated polyurethanes or acrylated polyethers. Further examples of unsaturated oligomers are unsaturated polyester resins which are usually prepared from maleic acid, phthalic acid and one or more diols and which have molecular weights of from about 500 Da to 3,000 Da. Such unsaturated oligomers can also be referred to as prepolymers.

Examples of compounds (a) which are particularly suitable for the implementation of the present invention, are esters of ethylenically unsaturated carboxylic acids and polyols or polyepoxides, and polymers containing ethylenically unsaturated groups in the chain or in side groups, e.g. unsaturated polyesters, polyamides and polyurethanes and copolymers thereof, alkyl resins, polybutadiene and butadiene copolymers, polyisoprene and isoprene copolymers, polymers and copolymers having (meth)acrylic groups in side chains, as well as mixtures thereof.

Illustrative examples of unsaturated carboxylic acids or anhydrides, useful for the preparation of the above esters, are acrylic acid, methacrylic acid, maleic anhydride, crotonic acid, itaconic acid, cinnamic acid and unsaturated fatty acids such as linolenic acid and oleic acid. Acrylic and methacrylic acid are preferred.

Examples of polyols, which can also be esterified, are aromatic and aliphatic and cycloaliphatic polyols, preferably aliphatic and cycloaliphatic polyols.

Aromatic polyols are, for example, hydroquinone, 4,4′-dihydroxydiphenyl, 2,2-di(4-hydroxyphenyl) propane, as well as novolaks and resoles. Polyepoxides, which can be esterified, include those based on the said polyols, especially the reaction products between aromatic polyols and epichlorohydrin. Also suitable as polyols are polymers and copolymers that contain hydroxyl groups in the polymer chain or in side groups, for example polyvinyl alcohol and copolymers thereof or polymethacrylic acid hydroxyalkyl esters or copolymers thereof. Further suitable polyols are oligoesters carrying hydroxyl terminal groups.

Examples of aliphatic and cycloaliphatic polyols include alkylenediols containing preferably from 2 to 12 carbon atoms, such as ethylene glycol, 1,2- or 1,3-propanediol, 1,2-, 1,3- or 1,4-butanediol, pentanediol, hexanediol, octanediol, dodecanediol, diethylene glycol, triethylene glycol, polyethylene glycols having molecular weights of preferably from 200 Da to 1,500 Da, 1,3-cyclopentanediol, 1,2-, 1,3- or 1,4-cyclohexanediol, 1,4-dihydroxymethyl cyclohexane, glycerol, tris(p-hydroxy-ethyl)amine, trimethylolethane, trimethylolpropane, pentaerythritol, dipentaerythritol and sorbitol.

Further suitable ethylenically unsaturated compounds (a) are unsaturated polyamides obtained from unsaturated carboxylic acids and aromatic, aliphatic and cycloaliphatic polyamines having preferably from 2 to 6, preferably from 2 to 4, amino groups. Examples of such polyamines are: ethylenediamine, 1,2- or 1,3-propylenediamine, 1,2-, 1,3- or 1,4-butylenediamine, 1,5-pentylenediamine, 1,6-hexylenediamine, octylenediamine, dodecylene diamine, 1,4-diaminocyclohexane, isophoronediamine, phenylene diamine, bisphenylenediamine, di-(β-aminoethyl) ether, diethylene triamine, triethylenetetramine and di(β-aminoethoxy)- and di(β-aminopropoxy)ethane. Other suitable polyamines are polymers and copolymers which may contain additional amino groups in the side chain and oligoamides containing amino end groups.

Specific examples of such unsaturated polyamides are methylenebisacrylamide, 1,6-hexamethylene bisacrylamide, diethylenetriamine trismethacrylamide, bis(methacrylamidopropoxy) ethane and N-[(p-hydroxyethoxy)ethyl]-acrylamide.

Unsaturated polyurethanes are also suitable for the implementation of the present invention as components (a), for example those derived from saturated or unsaturated diisocyanates and unsaturated or saturated diols. Polybutadiene and polyisoprene and copolymers thereof may also be used. Suitable monomers include, for example, olefins, such as ethylene, propene, butene and hexene, (meth)acrylates, acrylonitrile, styrene and vinyl chloride.

Polymers having unsaturated (meth)acrylate groups in the side chain can also be used as component (a). They may typically be reaction products of epoxy resins based on novolac with (meth)acrylic acid; homo- or copolymers of vinyl alcohol or hydroxyalkyl derivatives thereof that have been esterified with (meth)acrylic acid; and homo- and co-polymers of (meth)acrylates that have been esterified with hydroxyalkyl (meth)acrylates.

According to a preferred embodiment, the photocurable composition further comprises a coinitiators (c), also referred to as accelerators.

Suitable examples of accelerators/coinitiators (c) are alcohols, thiols, thioethers, amines or ethers that have an available hydrogen, bonded to a carbon adjacent to the heteroatom, disulfides and phosphines, e.g. as described in EP 438 123 and GB 2 180 358.

Suitable examples of amine accelerators/co-initiators include, but are not limited to, aliphatic, cycloaliphatic, aromatic, aryl-aliphatic, heterocyclic, oligomeric or polymeric amines. They can be primary, secondary or tertiary amines, for example butyl amine, dibutyl amine, tributyl amine, cyclohexyl amine, benzyldimethyl amine, di-cyclohexyl amine, N-phenyl glycine, triethyl amine, phenyl-diethanol amine, triethanolamine, piperidine, piperazine, morpholine, pyridine, quinoline, esters of dimethylamino benzoic acid, Michler's ketone (4,4′-bis-dimethyl aminobenzophenone) and derivatives thereof.

As the amine accelerators/co-initiators, an amine-modified acrylate compound can be used; examples of such amine-modified acrylate include acrylates modified by reaction with a primary or secondary amine that are described in U.S. Pat. No. 3,844,916, EP 280222, U.S. Pat. No. 5,482,649 or U.S. Pat. No. 5,734,002.

Multifunctional amine and polymeric amine derivatives are also suitable as co-initiators some examples are Omnipol® ASA from IGM Resins B.V., Genopol® AB-2 from Rahn A.G., Speedcure® 7040 from Lambson Limited or those described in US2013/0012611.

The photocurable compositions of the present invention can also comprise one or more of the following components: (d) photosensitizers and/or (e) further photoinitiators and/or (f) conventional additives, in addition to compounds (a), (b) and, when present, (c).

The photocurable compositions of the present invention can also be formulated in compositions further comprising water and/or solvents, such as organic solvents.

Photosensitizers (d) can be present in an amount comprised between 0.01 and 15% by weight, based on the total content of the composition, preferably between 0.01 and 10% by weight.

Examples of photosensitizers are those commonly used in the art, aromatic carbonyl compounds, e.g. benzophenones, thioxanthones, anthraquinones, coumarins and 3-acylcoumarin derivatives, terphenyls, styryl ketones, and 3-(aroylmethylene)-thiazolines, camphorquinones and also eosin, rhodamine and erythrosine dyes.

Examples of thioxanthones are thioxanthone, 2-isopropyl thioxanthone, 2-chloro thioxanthone, 2-dodecyl thioxanthone, 2,4-diethyl thioxanthone, 2,4-dimethyl thioxanthone, 1-methoxycarbonyl thioxanthone, 2-ethoxycarbonyl thioxanthone, 3-(2-methoxyethoxycarbonyl) thioxanthone, 4-butoxycarbonyl thioxanthone, 3-butoxycarbonyl-7-methyl thioxanthone, 1-cyano-3-chloro thioxanthone, 1-ethoxycarbonyl-3-chloro thioxanthone, 1-ethoxycarbonyl-3-ethoxy thioxanthone, 1-ethoxycarbonyl-3-amino thioxanthone, 1-ethoxycarbonyl-3-phenylsulfuryl thioxanthone, 3,4-di[2-(2-methoxyethoxy)ethoxycarbonyl] thioxanthone, 1-ethoxycarbonyl-3-(1-methyl-1-morpholinoethyl) thioxanthone, 2-methyl-6-dimethoxymethyl thioxanthone, 2-methyl-6-(1,1-dimethoxybenzyl) thioxanthone, 2-morpholinomethyl thioxanthone, 2-methyl-6-morpholinomethyl thioxanthone, N-allylthioxanthone-3,4-dicarboximide, N-octylthioxanthone-3,4-dicarboximide, N-(1,1,3,3-tetramethylbutyl)-thioxanthone-3,4-dicarboximide, 1-phenoxy thioxanthone, 6-ethoxycarbonyl-1-2-methoxythioxanthone, 6-ethoxycarbonyl-2-methylthioxanthone, thioxanthone-2-polyethylene glycol ester, 2-hydroxy-3-(3,4-dimethyl-9-oxo-9H-thioxanthon-2-yloxy)-N,N,N-trimethyl-1-propanaminium chloride, or those described in the patent application PCT/EP2011/069514, such as n-dodecyl-7-methyl-thioxanthone-3-carboxylate and N,N-disobutyl-7-methyl-thioxanthone-3-carbamide. Also suitable are polymeric thioxanthone derivatives (e.g. Omnipol® TX from IGM Resins B.V., Genopol® TX-1 from Rahn A.G., Speedcure® 7010 from Lambson Limited).

Example of benzophenones are benzophenone, 4-phenyl benzophenone, 4-methoxy benzophenone, 4,4′-dimethoxybenzophenone, 4,4′-dimethyl benzophenone, 4,4′-dichloro benzophenone, 4,4′-dimethylamino benzophenone, 4,4′-diethylamino benzophenone, 4-methyl benzophenone, 2,4,6-trimethyl benzophenone, 4-(4-methylthiophenyl) benzophenone, 3,3′-dimethyl-4-methoxy benzophenone, methyl 2-benzoyl benzoate, 4-(2-hydroxyethylthio) benzophenone, 4-(4-tolylthio) benzophenone, 4-benzoyl-N,N,N-trimethylbenzene methanaminium chloride, 2-hydroxy-3-(4-benzoylphenoxy)-N,N,N-trimethyl-1-propanaminium chloride monohydrate, 4-(13-acryloyl-1,4,7,10,13-pentaoxatridecyl) benzophenone, 4-benzoyl-N,N-dimethyl-N-[2-(1-oxo-2-propenyl)oxylethyl-benzene methanaminium chloride, or those described in U.S. Pat. No. 9,938,231 (e.g. Omnirad® 991 from IGM Resins B.V.).

Also suitable are polymeric benzophenone derivatives (e.g. Omnipol® BP, Omnipol® 2702 and Omnipol® 682 all from IGM Resins B.V., Genopol® BP-2 from Rahn A.G. and Speedcure® 7005 from Lambson Limited).

Examples of 3-acylcoumarin derivatives are 3-benzoyl coumarin, 3-benzoyl-7-methoxy coumarin, 3-benzoyl-5,7-di(propoxy) coumarin, 3-benzoyl-6,8-dichloro coumarin, 3-benzoyl-6-chloro coumarin, 3,3′-carbonyl-bis[5,7-di(propoxy) coumarin], 3,3′-carbonyl-bis(7-methoxy coumarin), 3,3′-carbonyl-bis(7-diethylamino coumarin), 3-isobutyroyl coumarin, 3-benzoyl-5,7-dimethoxy coumarin, 3-benzoyl-5,7-diethoxy coumarin, 3-benzoyl-5,7-dibutoxy coumarin, 3-benzoyl-5,7-di(methoxyethoxy) coumarin, 3-benzoyl-5,7-di(allyloxy) coumarin, 3-benzoyl-7-dimethylamino coumarin, 3-benzoyl-7-diethylamino coumarin, 3-isobutyroyl-1,7-dimethylamino coumarin, 5,7-dimethoxy-3-(1-naphthoyl) coumarin, 5,7-dimethoxy-3(1-naphthoyl)-coumarin, 3-benzoylbenzo [f]coumarin, 7-diethylamino-3-thienoyl coumarin, 3-(4-cyanobenzoyl)-5,7-dimethoxy coumarin, or those described in EP2909243 and WO2017216699.

Examples of 3-(aroylmethylene) thiazolines are 3-methy-1,2-benzoylmethylene-β-naphtho thiazoline, 3-methyl-2-benzoylmethylene-benzo thiazoline, 3-ethyl-2-propionylmethylene-β-naphtho thiazoline.

Examples of other aromatic carbonyl compounds are acetophenone, 3-methoxyacetophenone, 4-phenylacetophenone, benzyl, such as that described in WO 2013/164394, 2-acetylnaphthalene, 2-naphthaldehyde, 9,10-anthraquinone, 9-fluorenone, dibenzosuberone, xanthone, 2,5-bis(4-diethylaminobenzylidene) cyclopentanone, α-(para-dimethylamino benzylidene), ketones, such as 2-(4-dimethylamino-benzylidene)-indan-1-one or 3-(4-dimethylaminophenyl)-1-indan-5-yl-propenone, 3-phenylthiophthalimide, N-methyl-3,5-di(ethylthio) phthalimide.

Particularly preferred are thioxanthones, coumarins and 3-acylcoumarins. It was observed that the above components (d) increase the activity of photoinitiators (b) without shortening the shelf life of the compositions. Moreover, such compositions have the special advantage that an appropriate choice of the photosensitizer (d) allows the spectral sensitivity of photoinitioator (b) to be shifted to any desired wavelength region. The skilled in the art is able to select the suitable photosensitizer (d) to make the photoinitiator(s) (b) work at any desired wavelength region.

The further possible photoinitiators (e) can be present in an amount comprised between 0.5 and 15% by weight, of the total content of the composition, preferably between 1 and 10% by weight of the composition.

Examples of other suitable photoinitiators (e) are camphorquinone, benzophenone, benzophenone derivatives, acetophenone, acetophenone derivatives, dialkoxyacetophenones, α-hydroxyketones, α-aminoketones, 4-aroyl-1,3-dioxolanes, benzoin alkyl ethers and benzil ketals, e.g. benzil dimethyl ketal, ketosulfones, e.g 1-[4-[(4-benzoyl-phenyl)-thio]-phenyl]-2-methyl-2-[(4-methyl-phenyl)-sulfonyl]-propan-1-one (Esacure® 1001, from IGM Resins B.V.), 3-ketocoumarins, for example as described in EP2909243 and WO2017216699, phenylglyoxylates and derivatives thereof, dimeric phenyl glyoxylates, peresters, e.g. benzophenonetetracarboxylic acid peresters, for example as described in EP 126 541, acylphosphine photoinitiators (which can be chosen among mono-acylphosphine oxides, bis-acylphosphine oxides, tris-acylphosphine oxides and multifunctional mono- or bisacylphosphine oxides), halomethyltriazines, hexaaryl bisimidazole/coinitiator systems, e.g. ortho-chlorohexaphenylbisimidazole in combination with 2-mercaptobenzothiazole, ferrocenium compounds or titanocenes, for example dicyclopentadienyl-bis(2,6-difluoro-3-pyrrolo-phenyl)titanium, O-acyloxime ester photoinitiators.

Examples of α-hydroxyketones and α-aminoketones are 1-hydroxy cyclohexylphenyl ketone, 2-hydroxy-2-methyl-1-phenyl-propane-1-one, 1-[4-(2-hydroxyethoxy)phenyl]-2-hydroxy-2-methyl-1-propane-1-one, 2-hydroxy-1-{4-[4-(2-hydroxy-2-methyl-propionyl)-benzyl]phenyl}-2-methyl-propane-1-one), 2-hydroxy-1-{4-[4-(2-hydroxy-2-methyl-propionyl)-phenoxy]-phenyl}-2-methyl-propan-1-one, 2-methyl-1-(4-methylthiophenyl)-2-morpholinopropane-1-one), 2-benzyl-2-dimethylamino-1-(4-morpholinophenyl)-butane-1-one, and (2-(dimethylamino)-2-[(4-methylphenyl)methyl]-1-[4-(4-morpholinyl) phenyl]-1-butanone).

Examples of O-acyloxime ester photoinitiators are 1,2-octanedione,1-[4-(phenylthio)phenyl]-2-(O-benzoyloxime), ethanone 1-[9-ethyl-6-(2-methylbenzoyl)-9H-carbazole-3-yl] 1-(O-acetyloxime) or those described in GB 2339571.

Examples of acylphosphine photoinitiators include, but are not limited to, bis(2,4,6-trimethylbenzoyl)phenylphosphine oxide, bis(2,6-dimethoxybenzoyl)-2,4,4-trimethylpentyl phosphine oxide, bis(2,4,6-trimethylbenzoyl)-(2,4-dipentyloxyphenyl), 2,4,6-trimethylbenzoyl-diphenyl phosphine oxide and ethyl (2,4,6-trimethylbenzoyl) phenylphosphinate, Phenyl(2,4,6-trimethylbenzoyl)phosphinic acid, glycerol ethoxylated trimester (Omnipol® TP from IGM Resins B.V.).

Examples of the halomethyltriazines based photoinitiators are 2-[2-(4-methoxy-phenyl)-vinyl]-4,6-bis-trichloromethyl [1,3,5]triazine, 2-(4-methoxy-phenyl)-4,6-bis-trichloromethyl [1,3,5]triazine, 2-(3,4-dimethoxyphenyl)-4,6-bis-trichloromethyl [1,3,5]triazine, 2-methyl-4,6-bis-trichloromethyl [1,3,5] triazine.

Cationic photoinitiators can be also used as the further photoinitiators (e), when the photocurable compositions according to the invention are used in hybrid systems (which in this connection mean mixtures of free-radically and cationically curing systems). Examples of suitable cationic photoinitiators are aromatic sulfonium, phosphonium or iodonium salts, as described e.g. in U.S. Pat. No. 4,950,581, or cyclopentadienylarene-iron(II) complex salts, e.g. (η⁶-isopropylbenzene)(η⁵-cyclopentadienyl) iron(II) hexafluorophosphate or photolatent acids based on oximes, as described, for example, in GB 2 348 644, U.S. Pat. Nos. 4,450,598, 4,136,055, WO 00/10972 and WO 00/26219.

The photocuring composition according to the invention may also comprise conventional additives, from 0 to 10% based on the total content of the composition. Additives (f) can be, for example, thermal initiators, binders, stabilizers, and mixture thereof.

The choice of additives is governed by the field of use in question and the properties desired for that field. The additives (f) described above are known in the art and are accordingly used in the amounts conventionally used in the art.

For instance, especially in the case of pigmented compositions, the composition may also comprise, as additional additive (f), a thermal initiator, a compound that forms free radicals when heated, e.g. an azo compounds, such as 2,2′-azobis(4-methoxy-2,4-dimethylvaleronitrile), a triazene, diazosulfide, pentazadiene or a peroxy compound, for example a hydroperoxide or peroxycarbonate, e.g. tert-butyl hydroperoxide, as described e.g. in EP 245 639.

Binders may also be added to the photocurable composition of the invention. The addition of binders is particularly advantageous when the photocurable compounds are liquid or viscous substances. The amount of binder may be, for example, from 5 to 60% by weight, preferably from 10 to 50% by weight, based on the total content of the composition, excluding possible water and solvents. The choice of binder is made in accordance with the field of use and the properties required therefor, such as developability in aqueous and organic solvent systems, adhesion to substrates and sensitivity to oxygen.

Suitable binders are, for example, polymers having a weight average molecular weight (Mw) of approximately from 5,000 Da to 2,000,000 Da, preferably from 10,000 Da to 1,000,000 Da. Illustrative examples are: homo- and copolymers of acrylates and methacrylates, e.g. copolymers of methyl methacrylate/ethyl acrylate/methacrylic acid, poly(methacrylic acid alkyl esters), poly(acrylic acid alkyl esters); cellulose esters and ethers, such as cellulose acetate, cellulose acetate butyrate, methylcellulose, ethylcellulose, polyvinylbutyral, polyvinylformal, cyclised rubber, polyethers such as polyethylene oxide, polypropylene oxide, polytetrahydrofuran, polystyrene, polycarbonates, polyurethanes, chlorinated polyolefins, e.g. polyvinyl chloride, co-polymers of vinyl chloride/vinylidene chloride, co-polymers of vinylidene chloride with acrylonitrile, methyl methacrylate and vinyl acetate, polyvinyl acetate, co-poly (ethylene/vinyl acetate), polymers such as polycaprolactam and poly(hexamethylene adipamide), polyesters such as poly(ethylene glycol terephthalate) and poly(hexamethylene glycol succinate).

Suitable stabilizers are, for example, thermal inhibitors, such as hydroquinone, hydroquinone derivatives, p-methoxyphenol, β-naphthol or sterically hindered phenols, e.g. 2,6-di(tert-butyl)-p-cresol, which prevent premature polymerization. In order to increase dark storage stability it is possible to use, for example, copper compounds, such as copper naphthenate, stearate or octoate, phosphorus compounds, for example triphenylphosphine, tributylphosphine, triethyl phosphite, triphenyl phosphite or tribenzyl phosphite, quaternary ammonium compounds, e.g. tetramethylammonium chloride or trimethylbenzylammonium chloride, or hydroxylamine derivatives, e.g. N,N-diethylhydroxylamine. For the purpose of excluding atmospheric oxygen during polymerization it is possible to add paraffin or similar wax-like substances which, being insoluble in the polymer, migrate to the surface at the beginning of the polymerization and form a transparent surface layer which prevents air from entering.

It is also possible to add a light stabilizer, such as UV absorbers, e.g. hydroxyphenylbenzotriazole, hydroxyphenylbenzophenone, oxalic acid amide or hydroxyphenyl-s-triazine type. Such components can be used on their own or in the form of mixtures, with or without the use of sterically hindered amines (HALS).

The photocurable compositions according to the invention may also comprise, as further additives (f), photoreducible dyes, e.g. a xanthene, benzoxanthene, benzothioxanthene, thiazine, pyronin, porphyrin or acridine dye, and/or radiation cleavable trihalomethyl compounds. These compounds are described, for example, in EP445624.

Further customary additives (f) are, depending upon the intended use, optical brighteners, fillers, pigments, both white and colored pigments, colorants, antistatics, wetting agents or flow improvers. Additives conventionally used in the art, e.g. antistatics, flow improvers and adhesion enhancers, can also be used.

In addition to the above components, other components may be present in the composition of the invention.

It is also possible for chain-transfer reagents conventionally used in the art to be added to the compositions according to the invention. Examples are mercaptans, amines and benzothiazole.

The composition of the invention may also comprise colorants and/or colored pigments. Depending upon the intended use, both inorganic and organic pigments may be used. Such additives are well known to the person skilled in the art; some examples are carbon black, iron oxides, such as iron oxide yellow, iron oxide red, chromium yellow, chromium green, nickel titanium yellow, ultramarine blue, cobalt blue, bismuth vanadate, cadmium yellow and cadmium red. Examples of organic pigments are mono- or bis-azo pigments, and also metal complexes thereof, phthalocyanine pigments, polycyclic pigments, e.g. perylene, anthraquinone, thioindigo, quinacridone or triphenylmethane pigments, and also diketo-pyrrolo-pyrrole, isoindolinone, e.g. tetrachloroisoindolinone, isoindoline, dioxazine, benzimidazolone and quinophthalone pigments. The pigments may be used in the formulations on their own or in admixture.

Depending upon the intended use, the pigments can be added to the formulations in amounts conventionally used in the art, for example in an amount from 0.1 to 30% by weight or from 10 to 25% by weight, based on the total weight of the composition.

The composition may also comprise, for example, organic colorants of an extremely wide variety of classes. Examples are azo dyes, methine dyes, anthraquinone dyes and metal complex dyes. Usual concentrations are, for example, from 0.1 to 20% wt, especially from 1 to 5% wt, based on the total weight of the composition.

The photocurable compositions of the invention may comprise water.

The photocurable compositions of the invention are suitable for various purposes, for example as a printing ink, such as screen printing inks, flexographic printing inks, offset printing inks and inkjet printing inks, as clearcoats, as colored coats, for example for wood or metal, as powder coatings, as coating materials inter alia for paper, wood, metal or plastics, as daylight-curable paints for marking structures and roads, for photographic reproduction processes, for holographic recording materials, for image-recording processes or in the production of printing plates that can be developed using organic solvents or using aqueous-alkaline media, for the production of masks for screen printing, as dental filling compounds, as adhesives, as pressure-sensitive adhesives, as laminating resins, as photoresists, e.g. galvanoresists, as etch resists or permanent resists, both liquid and dry films, as photostructurable dielectrics, and as solder masks for electronic circuits, as resists in the production of color filters for any type of display screen or in the creation of structures during the manufacture of plasma displays and electroluminescent displays, in the production of optical switches, optical gratings (interference gratings), in the manufacture of three-dimensional articles by bulk curing (UV curing in transparent moulds) or according to the stereolithography process, as described, for example, in U.S. Pat. No. 4,575,330, in the manufacture of composite materials (e.g. styrene polyesters which may include glass fibers and/or other fibers and other adjuvants) and other methods of printing in three dimensions well-known to one skilled in the art, in the coating or sealing of electronic components or as coatings for optical fibers.

The photocurable compositions of the invention are also suitable for the production of optical lenses, e.g. contact lenses or Fresnel lenses, in the manufacture of medical apparatus, aids or implants, in dry film paints.

The photocurable compositions of the invention are also suitable for the preparation of gels having thermotropic properties. Such gels are described for example in DE 19700064 and EP 678534.

An article comprising a compound of formulae (I) or (II), or comprising a photocurable composition of the invention, represents a further subject-matter of the invention.

The compounds and compositions according to the invention may also be used as free-radical photoinitiators or photoinitiating systems for radiation-curable powder coatings.

The photocurable compositions according to the invention are suitable, for example, as coating materials for all kinds of substrate, for example wood, textiles, paper, ceramics, glass, plastics, such as polyesters, polyethylene terephthalate, polyolefins and cellulose acetate, especially in the form of films, and also metals, such as Al, Cu, Ni, Fe, Zn, Mg or Co and GaAs, Si or SiO₂, to which a protective layer is to be applied or an image is to be applied e.g. by imagewise exposure.

According to another of its aspects, it is a further subject-matter of the invention a process for photocuring photopolymerizable compositions coatings, adhesives and inks, which process comprises:
(i) providing a photopolymerizable composition as above defined;
(ii) coating or printing said photopolymerizable composition onto a substrate; and
(iii) photopolymerizing said coated or printed composition with a light source on said substrate.

According to another of its aspects, it is a further subject-matter of the invention a process for three-dimensional printing which comprising photocuring with a light source a mixture comprising the composition of the invention.

According to a preferred embodiment, the photopolymerizable composition used the processes of the invention comprises at least components (a), (b), (c), more preferably at least (a), (b), (c), and (d) as above defined.

A large number of the most varied kinds of light source may be used, the light source emitting at wavelengths from approximately 200 nm to approximately 800 nm. Both point sources and planiform radiators (lamp carpets) are suitable. Examples are: carbon arc lamps, xenon arc lamps, medium pressure, high pressure and low pressure mercury arc radiators, doped, where appropriate, with metal halides (metal halide lamps), microwave-excited metal vapour lamps, excimer lamps, superactinic fluorescent tubes, fluorescent lamps, argon incandescent lamps, flash lamps, photographic floodlight lamps, light-emitting diodes (LED), electron beams, X-rays and lasers.

According to one embodiment, said light source comprises UV light in at least one of the UVA, UVB and UVC ranges.

According to a preferred embodiment, said light source is a LED source, particularly preferred are LED light source emitting at wavelengths comprised between 365 nm and 420 nm, more preferably at 365 nm, 385 nm and 395 nm.

According to the invention the distance between the lamp and the substrate to be exposed may vary according to the intended use and the type and strength of the lamp, e.g. from 0.1 cm to 150 cm, preferably from 1 cm to 50 cm.

Said photopolymerizable composition may also be applied over a substrate already comprising a coated or printed layer. Said photopolymerizable composition may, after photopolymerization with said light source, be overprinted or overcoated with one or more compositions suitable for printing or coating.

The article obtained by applying said photopolymerizable composition to said substrate by said means of coating or printing, and photopolymerizing by said light source, with or without further elaboration of the article by further coating or printing, represents a further subject-matter of this invention.

As said, we surprisingly found that compounds of formula (I) and (II) are effective as photoinitiatiors and their activity was incredibly increased compared to that of the silicon based PIs of prior art. The new compounds showed their great improvement in surface curing under LED and Hg lamps both in clear and pigmented systems.

The invention is illustrated in detail below by the following examples, which are illustrative and not limiting.

In case of inconsistencies between the chemical name and the chemical structure herein indicated, the chemical structure prevails.

### EXAMPLES

¹H NMR spectra were recorded with a Bruker Ascend 300 MHz NMR Spectrometer.

### Example 1

### Synthesis of 1-{4-[(4-benzoylphenyl)sulfanyl]phenyl}-2-methyl-2-[(1,1,2,2,2-pentamethyldisilan-1-yl)oxy]propan-1-one

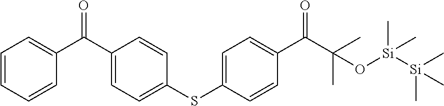 [SMILES: CC(C)(O[Si](C)(C)[Si](C)(C)C)C(=O)c1ccc(Sc2ccc(C(=O)c3ccccc3)cc2)cc1]

1-{4-[(4-benzoylphenyl)sulfanyl]phenyl}-2-hydroxy-2-methylpropan-1-one (2.5 g, 6.80 mmol) was dissolved in dichloromethane (20 mL), chloropentamethyldisilane (1.57 mL, 8.164 mmol) and imidazole (556 mg, 8.16 mmol) were added. Mixture was stirred at room temperature for two hours and then concentrated under reduced pressure. Crude was purified by flash chromatography on aluminum oxide (petroleum ether 2 cv; ethyl acetate/petroleum ether 5/95) to obtain 3.07 g of pure product (yield=89%).

¹H NMR (300 MHz, DMSO-d6): −0.04 (s, 9H), 0.14 (s, 6H), 1.5 (s, 6H), 7.43-7.53 (m, 4H), 7.53-7.61 (t, 2H), 7.64-7.78 (m, 5H), 8.02-8.13 (m, 2H).

### Example 2

### Synthesis of 2-methyl-1-[4-({4-[4-(morpholin-4-yl)benzoyl]phenyl}sulfanyl)phenyl]-2-[(1,1,2,2,2-pentamethyldisilan-1-yl)oxy]propan-1-one

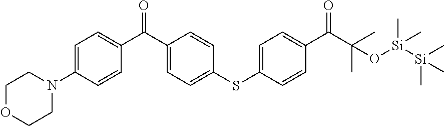 [SMILES: CC(C)(O[Si](C)(C)[Si](C)(C)C)C(=O)c1ccc(Sc2ccc(C(=O)c3ccc(N4CCOCC4)cc3)cc2)cc1]

To a solution of 2-hydroxy-2-methyl-1-[4-({4-[4-(morpholin-4-yl)benzoyl]phenyl}sulfanyl)phenyl]propan-1-one (1 g, 2.166 mmol) in dichloromethane (10 mL), chloropentamethyldisilane (501 μL, 2.6 mmol) and imidazole (177 mg; 2.6 mmol) were added. Mixture was stirred at room temperature for three hours and then concentrated under reduced pressure. Crude was purified by flash chromatography on aluminum oxide (petroleum ether 2 cv; ethyl acetate/petroleum ether 30/70) to obtain 832 mg of pure product (yield=65%).

¹H NMR (300 MHz, DMSO-d6): −0.03 (s, 9H), 0.17 (s, 6H), 1.5 (s, 6H), 3.28-3.37 (m, 4H), 3.71-3.77 (m, 4H), 6.98-7.07 (d, 2H), 7.40-7.54 (m, 4H), 7.61-7.72 (d, 4H), 8.01-8.10 (d, 2H).

### Example 3

### Synthesis of 1-[4-(4-benzoylphenoxy)phenyl]-2-methyl-2-[(1,1,2,2,2-pentamethyldisilan-1-yl)oxy]propan-1-one

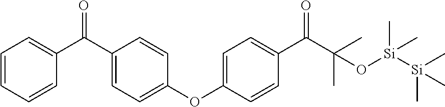 [SMILES: CC(C)(O[Si](C)(C)[Si](C)(C)C)C(=O)c1ccc(Oc2ccc(C(=O)c3ccccc3)cc2)cc1]

1-[4-(4-benzoylphenoxy)phenyl]-2-hydroxy-2-methylpropan-1-one (500 mg, 1.387 mmol) was dissolved in dichloromethane (5 mL), chloropentamethyldisilane (321 μL, 1.665 mmol) and imidazole (113 mg, 1.665 mmol) were added. Mixture was stirred at room temperature for two hours and then concentrated under reduced pressure. Crude was purified by flash chromatography on aluminum oxide (petroleum ether 2 cv; ethyl acetate/petroleum ether 5/95) to obtain 276 mg of pure product (yield=40%).

¹H NMR (300 MHz, DMSO-d6): −0.02 (s, 9H), 0.15 (s, 6H), 1.5 (s, 6H), 7.16-7.26 (m, 4H), 7.52-7.62 (t, 2H), 7.64-7.72 (m, 1H), 7.72-7.78 (m, 2H), 7.79-7.87 (m, 2H), 8.13-8.22 (m, 2H).

### Example 4

### Synthesis of 1-(6-benzoyl-9-ethyl-9H-carbazol-3-yl)-2-methyl-2-[(1,1,2,2,2-pentamethyldisilan-1-yl)oxy]propan-1-one

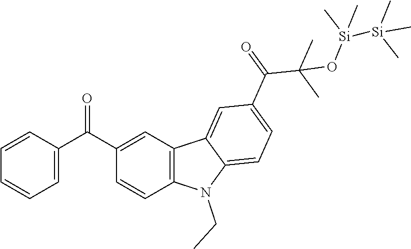 [SMILES: CCn1c2ccc(C(=O)c3ccccc3)cc2c2cc(C(=O)C(C)(C)O[Si](C)(C)[Si](C)(C)C)ccc21]

### Step 1. Synthesis of 1-(6-benzoyl-9-ethyl-9H-carbazol-3-yl)-2-chloro-2-methylpropan-1-one

In a three necked round bottom flask equipped with a thermometer 9-ethyl-9H-carbazole (1 g, 5.121 mmol) was dissolved in dichloromethane (10 mL), benzoyl chloride (637 μL, 5.48 mmol) and aluminum chloride (765 mg, 5.73 mmol) were added at 0° C. Mixture was stirred at room temperature for one hour under nitrogen atmosphere. Mixture was cooled to 0° C. and α-chloroisobutyryl bromide (1.21 g, 5.27 mmol) and aluminum chloride (737 mg, 5.531) were added. Mixture was stirred another hour at 15° C. and then quenched in ice, water (40 mL) and concentrated HCl (5 mL). Then it was stirred 10 minutes and organic phase was separated, washed with brine (20 mL) and dried over sodium sulfate. Crude was purified by flash chromatography on silica gel (ethyl acetate/petroleum ether 1/9) to obtain 1.27 g of pure product (yield=61%).

¹H NMR (300 MHz, DMSO-d6): 1.35-1.44 (t, 3H), 2.07-2.12 (s, 6H), 4.50-4.66 (q, 2H), 7.52-7.65 (t, 2H), 7.65-7.74 (m, 1H), 7.74-7.89 (m, 4H), 7.90-7.99 (dd, 1H), 8.27-8.38 (dd, 1H), 8.71-8.80 (d, 1H), 8.96-9.04 (d, 1H).

### Step 2. Synthesis of 1-(6-benzoyl-9-ethyl-9H-carbazol-3-yl)-2-hydroxy-2-methylpropan-1-one

To a solution of 1-(6-benzoyl-9-ethyl-9H-carbazol-3-yl)-2-chloro-2-methylpropan-1-one (1.13 mg, 2.79 mmol) and tetrabutylammonium bromide (9 mg, 0.03 mmol) in dichloromethane (4 mL), a solution of NaOH 30% in water (3.35 mmol) was added. Mixture was heated at reflux 24 hours.

Mixture was diluted with dichloromethane, washed with brine, dried over sodium sulfate and concentrated under reduced pressure. Crude was purified by flash chromatography (ethyl acetate/petroleum ether 3/7) to obtain 706 mg (66%) of pure product.

¹H NMR (300 MHz, DMSO-d6): 1.28-1.43 (t, 3H), 1.43-1.53 (s, 6H), 4.49-4.64 (q, 2H), 7.54-7.65 (m, 2H), 7.65-7.73 (m, 1H), 7.73-7.86 (m, 4H), 7.91-7.99 (dd, 1H), 8.36-8.45 (dd, 1H), 8.62-8.68 (d, 1H), 9.10-9.16 (d, 1H).

### Step 3. Synthesis of 1-(6-benzoyl-9-ethyl-9H-carbazol-3-yl)-2-methyl-2-[(1,1,2,2,2-pentamethyldisilan-1-yl)oxy]propan-1-one

1-(6-benzoyl-9-ethyl-9H-carbazol-3-yl)-2-hydroxy-2-methylpropan-1-one (634 mg, 1.645 mmol) was dissolved in dichloromethane (2 mL), chloropentamethyldisilane (381 μL, 1.974 mmol) and imidazole (134 mg, 1.974 mmol) were added. Mixture was stirred at room temperature for two hours and then concentrated under reduced pressure. Crude was purified by flash chromatography on aluminum oxide (petroleum ether 2 cv; ethyl acetate/petroleum ether 10/90) to obtain 773 mg of pure product (yield=91%).

¹H NMR (300 MHz, DMSO-d6): −0.07 (s, 9H), 0.15 (s, 6H), 1.32-1.43 (t, 3H), 1.57 (s, 6H), 4.48-4.66 (q, 2H), 7.52-7.64 (t, 2H), 7.65-7.73 (m, 1H), 7.73-7.82 (m, 3H), 7.82-7.90 (s, 1H), 7.95-8.04 (dd, 1H), 8.21-8.30 (dd, 1H), 8.62-8.68 (d, 1H), 9.10-9.16 (d, 1H).

### Example 5

### Synthesis of 1-(4-{[4-(4-fluorobenzoyl)phenyl]sulfanyl}phenyl)-2-methyl-2-[(1,1,2,2,2-pentamethyldisilan-1-yl)oxy]propan-1-one

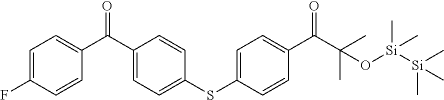 [SMILES: CC(C)(O[Si](C)(C)[Si](C)(C)C)C(=O)c1ccc(Sc2ccc(C(=O)c3ccc(F)cc3)cc2)cc1]

1-(4-{[4-(4-fluorobenzoyl)phenyl]sulfanyl}phenyl)-2-hydroxy-2-methylpropan-1-one (1 g, 2.535 mmol) was dissolved in dichloromethane (2 mL), chloropentamethyldisilane (587 μL, 3.042 mmol) and imidazole (207 mg, 3.042 mmol) were added. Mixture was stirred at room temperature for two hours and then concentrated under reduced pressure. Crude was purified by flash chromatography on aluminum oxide (petroleum ether 2 cv; ethyl acetate/petroleum ether 3/97) to obtain 680 mg of pure product (yield=51%).

¹H NMR (300 MHz, DMSO-d6): −0.4 (s, 9H), 0.14 (s, 6H), 1.51 (s, 6H), 7.34-7.44 (t, 2H), 7.45-7.55 (d, 4H), 7.69-7.77 (d, 2H), 7.78-7.88 (m, 2H), 8.04-8.12 (d, 2H).

### Example 6

### Synthesis of 1-(7-benzoyl-9H-fluoren-2-yl)-2-methyl-2-[(1,1,2,2,2-pentamethyldisilan-1-yl)oxy]propan-1-one

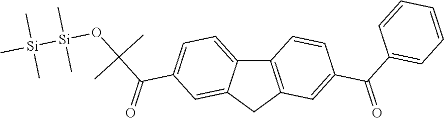 [SMILES: CC(C)(O[Si](C)(C)[Si](C)(C)C)C(=O)c1ccc2c(c1)Cc1cc(C(=O)c3ccccc3)ccc1-2]

### Step 1. Synthesis of 1-(7-benzoyl-9H-fluoren-2-yl)-2-chloro-2-methylpropan-1-one

In a three necked round bottom flask equipped with a thermometer 9H-fluorene (10 g, 60.161 mmol) was dissolved in dichloromethane (50 mL), benzoyl chloride (7.48 mL, 64.37 mmol) and aluminum chloride (8.98 g, 64.38 mmol) were added at 0° C. Mixture was stirred at room temperature for one hour under nitrogen atmosphere. Mixture was cooled to 0° C. and α-chloroisobutyryl bromide (14.24 g, 61.97 mmol) and aluminum chloride (8.66 g, 64.97 mmol) were added. Mixture was stirred another hour at 15° C. and then quenched in ice, water (40 mL) and concentrated HCl (5 mL). Then it was stirred 10 minutes and organic phase was separated, washed with brine (20 mL) and dried over sodium sulfate. Crude was precipitated in methanol to obtain 22.21 g (yield=98%) of a beige solid.

¹H NMR (300 MHz, DMSO-d6): 2.06 (s, 6H), 4.16 (s, 2H), 7.55-7.64 (t, 2H), 7.66-7.74 (m, 1H), 7.75-7.87 (m, 3H), 8.02 (s, 1H), 8.12-8.22 (m, 3H), 8.30 (s, 1H).

### Step 2. Synthesis of 1-(7-benzoyl-9H-fluoren-2-yl)-2-hydroxy-2-methylpropan-1-one

To a solution of 1-(7-benzoyl-9H-fluoren-2-yl)-2-chloro-2-methylpropan-1-one (22.21 g, 59.25 mmol) and tetrabutylammonium bromide (191 mg, 0.592 mmol) in dichloromethane (50 mL), a solution of NaOH 30% in water (71.1 mmol) was added. Mixture was heated at reflux 24 hours.

Mixture was diluted with dichloromethane, washed with brine, dried over sodium sulfate and concentrated under reduced pressure. Crude was purified by flash chromatography (ethyl acetate/petroleum ether 3/7) and then crystallized on toluene to obtain 6.5 g (yield=31%) of product.

¹H NMR (300 MHz, DMSO-d6): 1.45 (s, 6H), 4.12 (s, 2H), 7.52-7.64 (t, 2H), 7.65-7.74 (t, 1H), 7.74-7.91 (m, 3H), 8.00 (s, 1H), 8.07-8.21 (m, 2H), 8.23-8.33 (d, 1H), 8.44 (s, 1H).

### Step 3. Synthesis of 1-(7-benzoyl-9H-fluoren-2-yl)-2-methyl-2-[(1,1,2,2,2-pentamethyldisilan-1-yl)oxy]propan-1-one

1-(7-benzoyl-9H-fluoren-2-yl)-2-hydroxy-2-methylpropan-1-one (1 g, 2.806 mmol) was dissolved in dichloromethane (10 mL), chloropentamethyldisilane (649 μL, 3.367 mmol) and imidazole (229 mg, 3.367 mmol) were added. Mixture was stirred at room temperature for two hours and then concentrated under reduced pressure. Crude was purified by flash chromatography on aluminum oxide (petroleum ether 2 cv; ethyl acetate/petroleum ether 1/9) to obtain 1.08 g of pure product (yield=79%).

¹H NMR (300 MHz, DMSO-d6): −0.013 (s, 9H), 0.16 (s, 6H), 1.56 (s, 6H), 4.11 (s, 2H), 7.52-7.65 (t, 2H), 7.65-7.74 (m 1H), 7.74-7.87 (m, 3H), 8.01 (s, 1H), 8.08-8.24 (m, 3H), 8.36 (s, 1H).

By operating according to the methods of the Examples above, the following compounds may be synthesized:

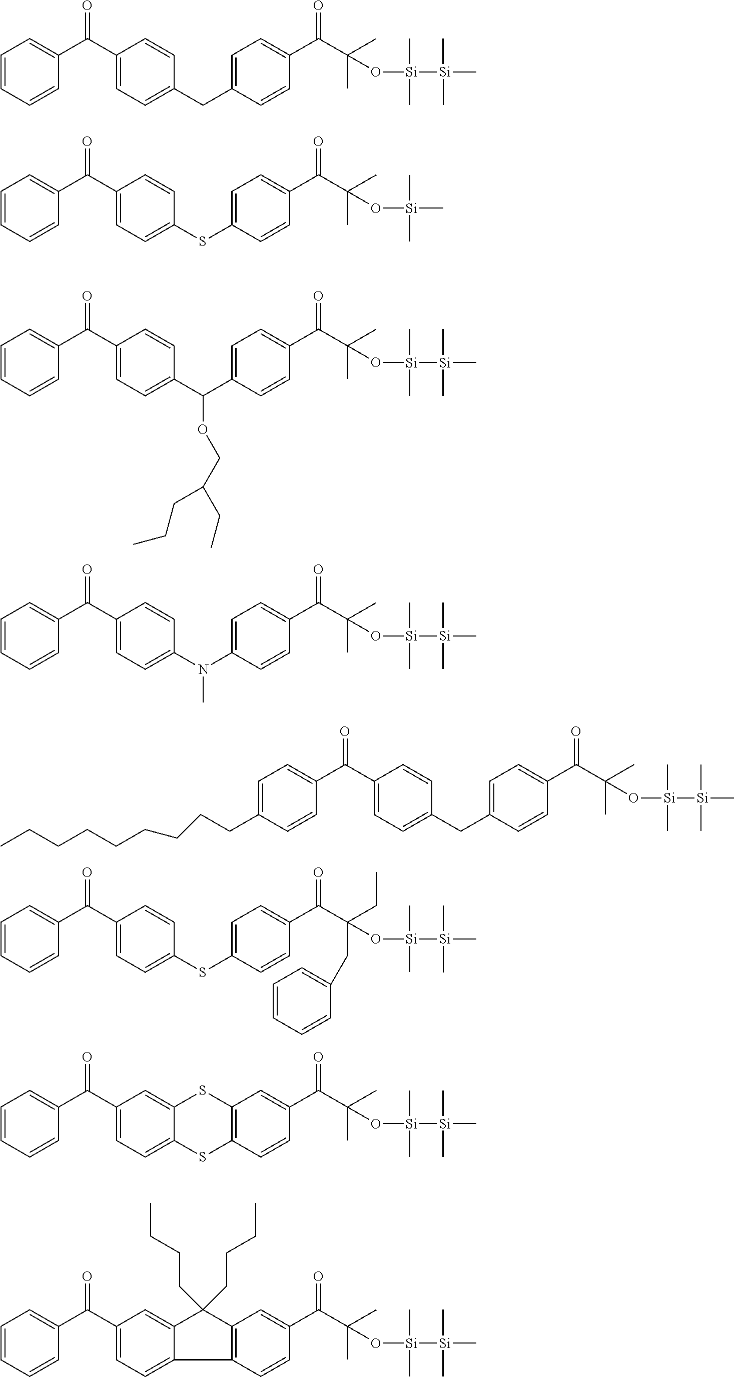

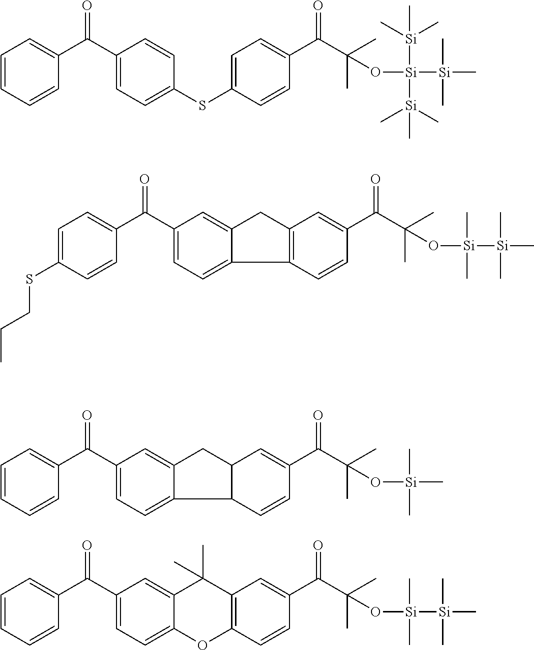 [SMILES: CC(C)(O[Si]([Si](C)(C)C)([Si](C)(C)C)[Si](C)(C)C)C(=O)c1ccc(Sc2ccc(C(=O)c3ccccc3)cc2)cc1 ; CCCSc1ccc(C(=O)c2ccc3c(c2)Cc2cc(C(=O)C(C)(C)O[Si](C)(C)[Si](C)(C)C)ccc2-3)cc1 ; CC(C)(O[Si](C)(C)C)C(=O)C1=CC2Cc3cc(C(=O)c4ccccc4)ccc3C2C=C1 ; CC(C)(O[Si](C)(C)[Si](C)(C)C)C(=O)c1ccc2c(c1)C(C)(C)c1cc(C(=O)c3ccccc3)ccc1O2]

### Comparative Tests

The bifunctional silicon photoinitiators (PIs) of the invention were compared with Example 5 of WO2020136522 (COMP-1) of formula

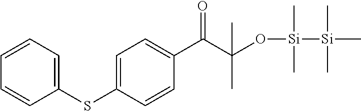 [SMILES: CC(C)(O[Si](C)(C)[Si](C)(C)C)C(=O)c1ccc(Sc2ccccc2)cc1]

### Example 7.1

### Comparative Tests

### Example 7.1.1

### Tack-Free Clear Coating Under Mercury (Ha) Lamp

The photopolymerizable compositions for the test were prepared by dissolving the photoinitiators at a concentration of 3% by wt each in a solution of Photomer 6577 (Aromatic urethane acrylate 10 F) 50%, Photomer 4335 (PETIA) 15%, Photomer 4666 (DPHA) 15%, Photomer 4172 (PPTTA) 20%. The coinitiator (Esacure A198) was added at the compositions in the same amount (3% by weight) when indicated.

The photopolymerizable composition is spread with a thickness of 12 microns on a varnished cardboard using a bar-coater. Therefore, is photopolymerized using a Mercury lamp (120 W/cm).

The results are expressed in meters per minutes as the maximum speed at which the tack-free is reached. (Table 1)

TABLE 1

| | Tack-free |
|---|---|
| Photoinitiator | (m/min) |
| COMP-1* | <10 |
| COMP-1 + | 26 |
| Esacure A198* | |
| Example 1 + | 67 |
| Esacure A 198 | |
| Example 2 + | 28 |
| Esacure A198 | |
| Example 6 + | 60 |
| Esacure A198 | |

*Comparative

The data reported in Table 1 strongly confirmed the great improvement obtained from the compounds of the invention compared to that of the prior art even when a coinitiator is added to said prior art compound.

### Example 7.1.2

### Tack-Free Clear Coating Under LED Lamp

At the photopolymerarizable compositions prepared as reported in the Example 7.1.1 were added 0.5% (by weight) of Omnirad ITX and were photopolymerized using an LED lamp at 395 nm (16 W/cm²).

The results are expressed in meters per minutes as the maximum speed at which the tack-free is reached. (Table 2)

TABLE 2

| | Tack-free |
|---|---|
| Photoinitiator | (m/min) |
| COMP-1* | <10 |
| COMP-1 + | 22 |
| Esacure A198* | |
| Example 1 + | 33 |
| Esacure A198 | |
| Example 2 + | 28 |
| Esacure A198 | |
| Example 6 + | 32 |
| Esacure A198 | |

*Comparative

The improvement in reactivity observed with the Mercury lamp (Example 7.1.1.) is confirmed also under LED lamp.

### Example 7.1.3

### Surface Curing and Through Cure in Cyan Offset Ink Under Mercury Lamp

The test formulations were prepared dissolving the photoinitiators at a concentration of 3% by weight (wt) in an industrial cyan offset ink. The coinitiator (Esacure A198) was added at the compositions in the same amount (3% by weight) when indicated. The test formulations were homogenized with a mechanical stirrer for 1 hour at 50° C. and applied onto a white cardboard at 1.5 microns of thickness using IGT repro-tester equipment.

The formulations were cured using a Mercury lamp (120 W/cm) at a distance of 8 cm.

For the surface cure the evaluation was carried out considering the number of passages at a speed of 100 m/min to obtain a dry surface (cotton test). Lower is the number of passages, better the surface cure.

The through cure test is a measurement of the complete ink cure obtained at a defined speed and checked by “thumb twist pressure test”. Higher speed corresponds to higher reactivity.

The results are shown in Table 3:

TABLE 3

Hg Lamp

| | Surface cure | |
|---|---|---|
| | pass number | Through cure |
| Photoinitiator | at 100 m/min | (m/min) |
| COMP-1* | >10 | <10 |
| COMP-1 + | 3 | 34 |
| Esacure A198* | | |
| Example 1 + | 2 | 70 |
| Esacure A198 | | |
| Example 2 + | 1 | 98 |
| Esacure A198 | | |
| Example 2 | 3 | 63 |
| Example 6 + | 1 | 81 |
| Esacure A198 | | |

*Comparative

These tests confirm that compounds of formulae (I) and (II) are very reactive as photoinitiators, and more effective than the prior art photoinitiator.

### Example 7.1.4

### Surface Curing and Through Cure in Cyan Offset Ink Under LED 395 nm Lamp

At the photopolymerarizable compositions prepared as reported in the Example 7.1.3 were added 0.5% (by weight) of Omnirad ITX and were photopolymerized using an LED lamp at 395 nm (16 W/cm2).

The results are expressed in meters per minutes as the maximum speed at which the through-cure is reached and in number of passages to obtain a dry surface. (Table 4)

TABLE 4

LED Lamp

| | Surface cure | |
|---|---|---|
| | pass number at | Through cure |
| Photoinitiator | 100 m/min | (m/min) |
| COMP-1* | >10 | <10 |
| COMP-1 + | 9 | 15 |
| Esacure A198* | | |
| Example 1 + | 2 | 98 |
| Esacure A198 | | |
| Example 2 + | 1 | >100 |
| Esacure A198 | | |
| Example 2 | 6 | >100 |
| Example 6 + | 1.5 | >100 |
| Esacure A198 | | |

*Comparative

All these tests confirm the very good reactivity of the compounds of the invention compared to the silicon based compound of the prior art. Such good performance are confirmed in presence but also in the absence of the coinitiator (c), and in many different conditions (clear, ink, different lamps).

1. A photocurable composition comprising:
a) from 50 to 99.9% by weight, based on the total content of the composition, of at least one ethylenically unsaturated compound; and
b) from 0.1 to 35% by weight, based on the total content of the composition, of at least one compound of formula (I) or (II) 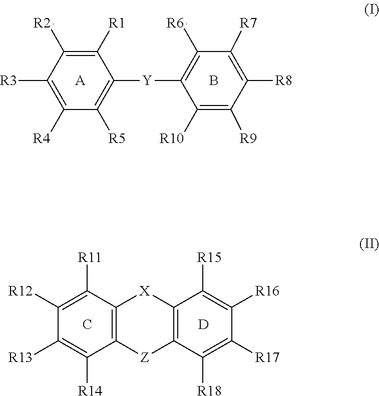
wherein:
at least one of R₁, R₂, R₃, R₄, R₅, R₆, R₇, R₅, R₉ and R₁₀ and at least one of R₁₁, R₁₂, R₁₃, R₁₄, R₁₅, R₁₆, R₁₇, R₁₈ comprises a group of formula (III); 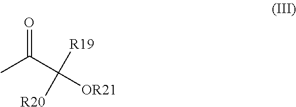
at least one of R₁, R₂, R₃, R₄, R₅, R₆, R₇, R₈, R₉ and R₁₀ and at least one of R₁₁, R₁₂, R₁₃, R₁₄, R₁₅, R₁₆, R₁₇, R₁₈ comprises a group of formula (IV) 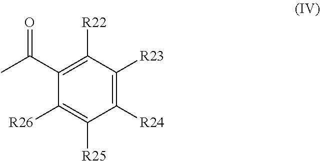
and the others, each independently, are selected from hydrogen, halogen, substituted or unsubstituted C1-C20 alkyl, C5-C7 cycloalkyl, C3-C12 alkenyl, —O(C3-C12 alkenyl), —S(C3-C12 alkenyl), aryl, substituted or unsubstituted C1-C20 alkoxy, C1-C50 alkyl which is interrupted by one or more oxygens, C5-C7 cycloalkoxy, aryloxy, substituted or unsubstituted C1-C20 alkylthio, arylthio, substituted or unsubstituted (C1-C12alkyl)₂amino, (C5-C7cycloalkyl)₂amino, morpholino, piperidino, piperazino and N(C1-C12alkyl)piperazino;
R₁₉ and R₂₀ are, each independently, are selected from C1-C20 alkyl, C5-C7 cycloalkyl, benzyl and CH₂tolyl;
R₂₁ is selected from Si(C1-C12alkyl)₂Si(C1-C12alkyl)₃, Si(C1-C12alkyl)₃, Si(Si(C1-C12alkyl)₃)₃, Si(C1-C12alkyl)₂Si(C1-C12alkyl)₂Si(C1-C12alkyl)₃, Si(C1-C12alkyl)₂Si(C1-C12alkyl)₂Si(C1-C12alkyl)₂Si(C1-C12alkyl)₃, Si(aryl)₃ and Si(aryl)₂Si(aryl)₃;
R₂₂, R₂₃, R₂₄, R₂₅ and R₂₆ are, each independently, selected from hydrogen, halogen, substituted or unsubstituted C1-C20 alkyl, C3-C12 alkenyl, COOH, COO(C1-C12 alkyl), O(C3-C12 alkenyl), S(C3-C12 alkenyl), C5-C7 cycloalkyl, aryl, substituted or unsubstituted C1-C20 alkoxy, C1-C50 alkyl which is interrupted by one or more oxygens, C5-C7 cycloalkoxy, aryloxy, substituted or unsubstituted C1-C20alkylthio, arylthio, substituted or unsubstituted (C1-C12alkyl)₂amino, (C5-C7cycloalkyl)₂amino, morpholino, piperidino, piperazino and N(C1-C12alkyl)piperazino;
X, Y and Z are each independently selected from O, S, Se, SO, SO2, NH, N(C1-C12alkyl), N-aryl, a direct bond, CH₂, C(C1-C12alkyl)₂, C(C1-C12alkoxy)₂, CH(C1-C12alkyl), CH(C1-C12alkoxy), CHOH, C(aryl)₂, CH(aryl), C(aryloxy)₂ and CH(aryloxy);
as well as salts and/or solvates thereof; and
c) from 0 to 20% by weight, based on the total content of the composition, of an accelerator and/or a coinitiator.

2. The photocurable composition of claim 1, wherein:
at least one of R₁, R₂, R₃, R₄, R₅, R₆, R₇, R₅, R₉ and R₁₀ and at least one of R₁₁, R₁₂, R₁₃, R₁₄, R₁₅, R₁₆, R₁₇, R₁₈ comprises a group of formula (III) 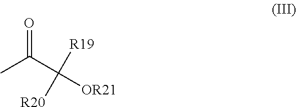
at least one of R₁, R₂, R₃, R₄, R₅, R₆, R₇, R₅, R₉ and R₁₀ and at least one of R₁₁, R₁₂, R₁₃, R₁₄, R₁₅, R₁₆, R₁₇, R₁₈ comprises a group of formula (IV) 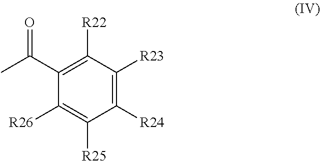
and the others are hydrogen;
Y is selected from O, S, CH₂, CHOH, CH(C1-C12alkoxy) and a direct bond;
X is selected from a direct bond, C(C1-C12alkyl)₂, S and CH₂;
Z is selected from O, S, CH₂, N(C1-C12alkyl), C(C1-C12alkyl)₂ and a direct bond;
R₁₉ and R₂₀ are C1-C12alkyl;
R₂₁ is selected from Si(C1-C12alkyl)₂Si(C1-C12alkyl)₃ and Si(C1-C12alkyl)₃;
R₂₂, R₂₃, R₂₅, and R₂₆ are hydrogen; and
R₂₄ is selected from hydrogen, halogen, substituted or unsubstituted C1-C20alkyl, aryl, substituted or unsubstituted C1-C20alkoxy, C1-C50alkyl which is interrupted by one or more oxygens, aryloxy, substituted or unsubstituted C1-C20alkylthio, arylthio, substituted or unsubstituted (C1-C12alkyl)₂amino, (C5-C7cycloalkyl)₂amino, morpholino, piperidino, piperazino and N(C1-C12alkyl)piperazino.

3. The photocurable composition of claim 1, further comprising one or more of the following components:
d) from 0.01 to 15% by weight based on the total content of the composition, of one or more photosensitizer; and
e) from 0.5 to 15% by weight based on the total content of the composition, one or more further photoinitiators.

4. A compound of formula (I) or (II): 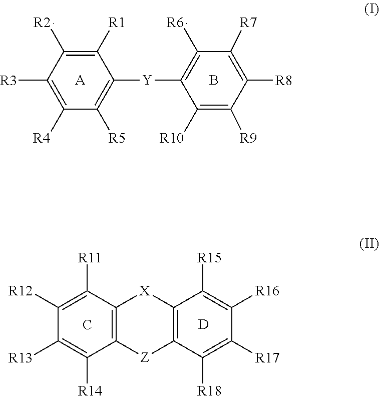
wherein:
at least one of R₁, R₂, R₃, R₄, R₅, R₆, R₇, R₈, R₉ and R₁₀ and at least one of R₁₁, R₁₂, R₁₃, R₁₄, R₁₅, R₁₆, R₁₇, R₁₈ comprises a group of formula (III); 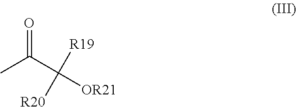
at least one of R₁, R₂, R₃, R₄, R₅, R₆, R₇, R₈, R₉ and R₁₀ and at least one of R₁₁, R₁₂, R₁₃, R₁₄, R₁₅, R₁₆, R₁₇, R₁₈ comprises a group of formula (IV) 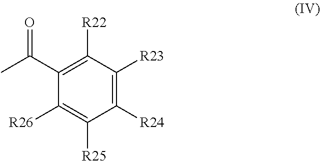
and the others, each independently, are selected from hydrogen, halogen, substituted or unsubstituted C1-C20alkyl, C5-C7cycloalkyl, C3-C12alkenyl, —O(C3-C12alkenyl), —S(C3-C12alkenyl), aryl, substituted or unsubstituted C1-C20 alkoxy, C1-C50alkyl which is interrupted by one or more oxygens, C5-C7cycloalkoxy, aryloxy, substituted or unsubstituted C1-C20 alkylthio, arylthio, substituted or unsubstituted (C1-C12alkyl)₂amino, (C5-C7cycloalkyl)₂amino, morpholino, piperidino, piperazino and N(C1-C12alkyl)piperazino;
R₁₉ and R₂₀ are, each independently, selected from C1-C20 alkyl, C5-C7cycloalkyl, benzyl and CH2tolyl;
R₂₁ is selected from Si(C1-C12alkyl)₂Si(C1-C12alkyl)₃, Si(C1-C12alkyl)₃, Si(Si(C1-C12alkyl)₃)₃, Si(C1-C12alkyl)₂, Si(C1-C12alkyl)₂Si(C1-C12alkyl)₃, Si(C1-C12alkyl)₂Si(C1-C12alkyl)₂Si(C1-C12alkyl)₂Si(C1-C12alkyl)₃, Si(aryl)₃ and Si(aryl)₂Si(aryl)₃;
R₂₂, R₂₃, R₂₄, R₂₅ and R₂₆ are, each independently, selected from hydrogen, halogen, substituted or unsubstituted C1-C20alkyl, C3-C12alkenyl, COOH, CO(C1-C12alkyl), O(C3-C12alkenyl), S(C3-C12alkenyl), C5-C7cycloalkyl, aryl, substituted or unsubstituted C1-C20 alkoxy, C1-C50 alkyl which is interrupted by one or more oxygens, C5-C7cycloalkoxy, aryloxy, substituted or unsubstituted C1-C20alkylthio, arylthio, substituted or unsubstituted (C1-C12alkyl)₂amino, (C5-C7cycloalkyl)₂amino, morpholino, piperidino, piperazino and N(C1-C12alkyl)piperazino; and
X, Y and Z are each independently selected from O, S, Se, SO, SO2, NH, N(C1-C12alkyl), N-aryl, a direct bond, CH₂, C(C1-C12alkyl)₂, C(C1-C12alkoxy)₂, CH(C1-C12alkyl), CH(C1-C12alkoxy), CHOH, C(aryl)₂, CH(aryl), C(aryloxy)₂ and CH(aryloxy); as well as salts and/or solvates thereof.

5. The compound of claim 4, wherein
at least one of R₁, R₂, R₃, R₄, R₅, R₆, R₇, R₅, R₉ and R₁₀ and at least one of R₁₁, R₁₂, R₁₃, R₁₄, R₁₅, R₁₆, R₁₇, R₁₈ comprises a group of formula (III) 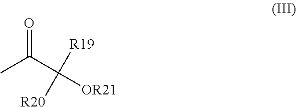
at least one of R₁, R₂, R₃, R₄, R₅, R₆, R₇, R₅, R₉ and R₁₀ and at least one of R₁₁, R₁₂, R₁₃, R₁₄, R₁₅, R₁₆, R₁₇, R₁₈ comprises a group of formula (IV) 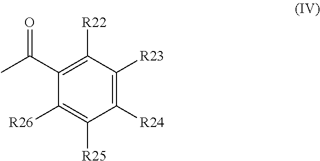
and the others are hydrogen;
Y is selected from O, S, CH₂, CHOH, CH(C1-C12alkoxy) and a direct bond;
X is selected from a direct bond, C(C1-C12alkyl)₂, S and CH₂;
Z is selected from O, S, CH₂, N(C1-C12alkyl), C(C1-C12alkyl)₂ and a direct bond;
R₁₉ and R₂₀ are C1-C12alkyl;
R₂₁ is selected from Si(C1-C12alkyl)₂Si(C1-C12alkyl)₃ and Si(C1-C12alkyl)₃;
R₂₂, R₂₃, R₂₅, and R₂₆ are hydrogen; and
R₂₄ is selected from hydrogen, halogen, substituted or unsubstituted C1-C20 alkyl, aryl, substituted or unsubstituted C1-C20 alkoxy, C1-C50 alkyl which is interrupted by one or more oxygens, aryloxy, substituted or unsubstituted C1-C20alkylthio, arylthio, substituted or unsubstituted (C1-C12alkyl)₂amino, (C5-C7cycloalkyl)₂amino, morpholino, piperidino, piperazino and N(C1-C12alkyl)piperazino.

6. A process for photocuring photopolymerizable compositions, coatings, adhesives and inks, which process comprises:
(i) providing a photopolymerizable composition as in claim 1;
(ii) coating or printing said photopolymerizable composition onto a substrate; and
(iii) photopolymerizing said coated or printed composition on said substrate with a light source.

7. A process for three-dimensional printing comprising providing a photopolymerizable composition as in claim 1 and photocuring said composition with a light source a mixture.

8. The process of claim 6, wherein said light source comprises UV light in at least one of the UVA, UVB and UVC ranges.

9. The process of claim 6, wherein said light source is a LED source emitting in the range from 350 to 420 nm.

10. The process of claim 6, further comprising a step of applying said photopolymerizable composition to a substrate prior to said photopolymerizing.

11. An article of manufacture obtained according to the process of claim 6.

12. An article of manufacture obtained according to the three-dimensional printing of a mixture comprising the composition according to claim 1.

13. An article of manufacture obtained according to the three-dimensional printing of a mixture comprising the composition according to claim 3.

14. An article of manufacture obtained according to the three-dimensional printing of a compound according to claim 4.

15. The process of claim 7, wherein said light source comprises UV light in at least one of the UVA, UVB and UVC ranges.

16. The process of claim 7, wherein said light source is a LED source emitting in the range from 350 to 420 nm.

17. The process of claim 8, wherein said light source is a LED source emitting in the range from 350 to 420 nm.

18. The process of claim 7, further comprising a step of applying said photopolymerizable composition to a substrate prior to said photopolymerizing.

19. The process of claim 8, further comprising a step of applying said photopolymerizable composition to a substrate prior to said photopolymerizing.

20. The process of claim 9, further comprising a step of applying said photopolymerizable composition to a substrate prior to said photopolymerizing.
